(19) United States
(12) Patent Application Publication
(10) Pub. No.: US 2011/0096406 A1
(43) Pub. Date: Apr. 28, 2011

(54) LIQUID-BASED OPTICAL DEVICE, METHOD FOR CONTROLLING SUCH A DEVICE AND ELECTRONIC DEVICE

(75) Inventors: Stein Kuiper, Eindhoven (NL); Bernardus H.W. Hendriks, Eindhoven (NL); Laura Huijbregts, Eindhoven (NL)

(73) Assignee: KONINKLIJKE PHILIPS ELECTRONICS, N.V., Eindhoven (NL)

(21) Appl. No.: 11/572,640

(22) PCT Filed: Jul. 28, 2005
(86) PCT No.: PCT/IB2005/052540

§ 371 Date: May 4, 2009

(30) Foreign Application Priority Data
Jul. 29, 2004 (GB) 0416884.5

(51) Int. Cl. G02B 3/12

(52) U.S. Cl. 359/665

(57) ABSTRACT

The present invention discloses an optical device comprising a container enclosing a first liquid (A) and an electrically susceptible second liquid (v2), said liquids (A; B) being immiscible and being in contact with each other via an interface (14); at least one of the liquids (A; B) being at least partially placed in a light path through the container; said liquids having an averaged kinematic viscosity V (in m²/s) and an averaged density D (in kg/m³). said liquids experiencing a surface tension S (in N/m), the optical device having a diameter d (in m) in at the contact line of said interface (14) with an inner wall of the container, the optical device obeying the relationship, (Formula I) Such an optical device has a critically damped or a near-critically damped interface, thus yielding a device that can be subjected to high switching frequencies.

The present invention relates to an optical device comprising a container enclosing a first liquid and an electrically susceptible second liquid, the first liquid and the electrically susceptible second liquid being immiscible and being in contact with each other via an interface, at least one of the liquids being at least partially placed in a light path through the container.

The present invention yet further relates to an electronic device comprising such an optical device.

Optical devices based on the manipulation of liquids are rapidly gaining large commercial interest, not in the least because of their lack of mechanically moving parts and the relative simplicity of the devices, which makes the devices cheap and durable.

For instance, in US patent application US2001/0017985 an optical device is disclosed that incorporates two immiscible liquids with equal refractive indices but different transmittances, with one of the two liquids being conductive. By varying the interface between these two liquids, the amount of each of the liquids in the light path through the device is changed and a diaphragm is obtained as a result.

International patent application WO03/069380 discloses a cylindrical variable focus lens incorporating two immiscible fluids having different refractive indices, one of the fluids being conductive and the other being insulating. These fluids preferably have a comparable density to avoid a gravitational dependency of the orientation of the liquids on the orientation of the lens. The shape of the interface between the two fluids is manipulated by applying a voltage across the lens, which can be used to introduce a change in the focal point of the lens. The walls of the cylinder and one of the transparent lids of the cylinder are coated with a hydrophobic coating to ensure that at least in a switched off state the electrically susceptible fluid, which typically is a polar or a polarizable liquid, does not wet said walls in order to maintain a well-defined interface between the fluids.

A problem with such liquid-based optical devices is that a change in the interface position can cause the formation of an oscillation on the interface, which deteriorates the optical integrity of the interface. This is difficult to avoid, and becomes an unwanted effect when the oscillation has a lifetime that is longer than the desired operational frequency of the optical device or the electronic device utilizing the functionality of the optical device, e.g., a mobile phone utilizing a liquid-based variable focus lens.

The invention seeks to provide an optical device in which the duration or the occurrence of interface oscillations is reduced.

The invention further seeks to provide an electronic device comprising such an optical device.

According to an aspect of the present invention, there is provided an optical device comprising a container enclosing a first liquid and an electrically susceptible second liquid, said liquids being immiscible and being in contact with each other via an interface; at least one of the liquids being at least partially placed in a light path through the container; said liquids having an averaged kinematic viscosity V (in m²/s) and an averaged density D (in kg/m³), said liquids experiencing a surface tension S (in N/m), the optical device having a diameter d (in m) at the contact line of said interface with the inner wall of the container, the optical device obeying the formula:

$$0.5 \leq 98 {V ( \frac{D}{Sd} )}^{0.5} \leq 5 \qquad ( 1 )$$

For an optical device obeying this formula, the characteristic damping time of oscillations on the interface of the optical device can be kept below 30 ms for an optical device having a diameter of up to at least 5 mm at the contact line of the interface with the inner wall of the container, that is, the diameter of the container at the point where the interface touches the inner wall thereof.

Advantageously, the optical device obeys the formula:

$$0.75 \leq 98 {V ( \frac{D}{Sd} )}^{0.5} \leq 2 \qquad ( 2 )$$

In this range, the interface oscillations are damped very quickly, and an effective (near-) critically damped optical device is achieved.

Preferably, the aforementioned ranges are obeyed in a temperature range of −30 to 60° Celsius, which for instance covers the required temperature range for a liquid-based variable focus lens.

According to another aspect of the invention, an electronic device comprising an optical device of the present invention is provided. Such an electronic device has the advantage that higher optical device utilization frequencies can be achieved, e.g., faster auto focussing or higher image capturing rates because the interface of the optical device settles quicker upon switching of the optical device than prior art liquid-based optical devices.

The invention is described in more detail and by way of non-limiting examples with reference to the accompanying drawings, wherein:

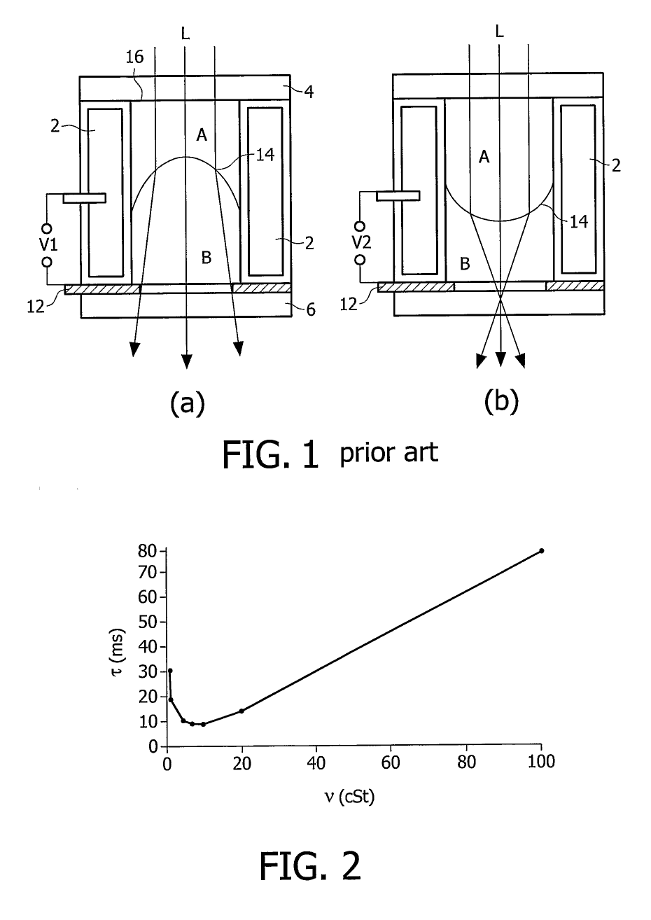

FIG. 1 schematically depicts a prior art variable focus lens; and

FIG. 2 depicts the damping time of an optical device as a function of kinematic viscosity.

It should be understood that the Figures are merely schematic and are not drawn to scale. It should also be understood that the same reference numerals are used throughout the Figures to indicate the same or similar parts.

In FIG. 1, a variable focus lens as disclosed in International Patent application WO 03/069380 is shown. The variable focus lens comprises a first fluid A and a second fluid B housed in a cylindrical chamber. The fluids are immiscible, have different refractive indices and preferably have the same density to avoid orientation-dependent gravitational effects on the orientation of the fluids including the interface 14 between the fluids. The cylindrical chamber further comprises a first end portion 4 and a second end portion 6, with the first end portion 4 as well as the inner walls of the cylindrical chamber being covered by a hydrophobic coating such as AF1600™ from the DuPont company, which may be combined with a parylene stack, to confine the conductive fluid B by the insulating fluid A in the absence of an applied voltage. The shape of the interface 14 can be switched in a continuous fashion from a convex shape shown in orientation (a) to a concave shape shown in orientation (b) by varying a voltage from a value V1 to a value V2 across the cylindrical electrode 2 embedded in the chamber wall and a, preferably transparent, annular electrode 12 on the second lid 6 which is in conductive contact with the second fluid B. Consequently, the focal point of the light path L through the cylinder is altered.

The transparent end portion 4 may be a glass or polymer lid or another suitable transparent material, which may be lens-shaped.

In order for such a lens, or a diaphragm as disclosed in US2001/0017985, to be suited for applications requiring fast response times, such as in digital still cameras or in mobile phones having variable focus lenses, it is important that the oscillations that can occur on the interface when the interface changes position and/or shape due to a switching of the optical device are critically damped. An underdamped device will still exhibit oscillations on the interface upon utilization of the optical function of the optical device, causing a deviation from the intended optical function, e.g. distortions in an image captured by the image sensor of an electronic device utilizing a liquid-based variable focus lens. On the other hand, an overdamped optical device will not suffer from these oscillations, but such a device has a slow response time, which is unwanted in electronic devices utilizing auto focus mechanisms, because it will take too long for the optical device, e.g., a variable focus lens, to become focussed.

It is emphasized that the need for a critically damped variable focus lens was already recognized by Bruno Berge et al. in the European Physical Journal E, 2000, vol. 3, pages 159-163. However, up until now, it was not possible to predict which of these three types of damping behaviours an optical device would exhibit, and in fact, to the best knowledge of the applicant of the present invention, no systems obeying the formula (I) are publically known yet.

The present invention is based on the realization that the critical damping time t of a liquid-based optical device can be approximated with the following formula:

$$t = 0.3 {( \frac{{d}^{3} D}{S} )}^{0.5} \qquad ( 3 )$$

This was verified by doing a series of measurements on a number of liquid-based lenses having varying diameters d and varying liquids A and B. In FIG. 2, an example of a number of measurements using a 0.1M solution of KCI in water as the electrically susceptible liquid and a range of silicone oils having different kinematic viscosities as the other liquid is given. On the y-axis, the damping time t is given as a function of the kinematic viscosity of the oils. For this particular range, it was found that a kinematic viscosity of around 7 centiStokes (cSt), that is, 7*10⁻⁶ m²/s for the silicone oil provided the fastest response time for the variable focus lens. From this and other experiments not shown, the empirical formulas 1 and 2 have been extracted.

An example of a two-liquid system obeying formula 2 is a 0.01 M solution of KCI in water as the electrically susceptible second liquid B and a poly-dimethyl-siloxane oil having a kinematic viscosity of 7*10⁻⁶ m²/s. For these two liquids in an optical device having a diameter d of 0.004 m, i.e., 4 mm, a damping time t of well below 25 ms was obtained, which makes this two-liquid system particularly suitable for application in camera lenses where a fast settling speed of the interface is required. Many other liquid combinations can be found obeying the formulas 1 and 2.

It is emphasized that although these undesirable effects are mainly explained using variable focus lenses such as the prior art variable focus lens from International Patent application WO 03/069380 as an example, other liquid-based optical devices such as the diaphragm disclosed in US patent application US2001/0017985 can also suffer from at least some of these problems.

It is emphasized that in the context of the present invention, the phrase optical device is not intended to limit the application domain of the devices of the present invention to the visible part of the electromagnetic spectrum. The invention can also be used for other parts of this spectrum, e.g., acoustic devices, without departing from the scope of the present invention.

It is also emphasized that the phrase electrically susceptible liquid is intended to include all liquids which behaviour can be manipulated by a force resulting from the application of an electric current or an electric field, such as polar liquids and polarizable liquids.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An optical device comprising:
a container enclosing a first liquid (A) and an electrically susceptible second liquid (B), said liquids (A;B) being immiscible and being in contact with each other via an interface (14); at least one of the liquids (A; B) being at least partially placed in a light path through the container; said liquids having an averaged kinematic viscosity V (in m²/s) and an averaged density D (in kg/m³), said liquids experiencing a surface tension S (in N/m), the optical device having a diameter d (in m) at the contact line of said interface (14) with an inner wall of the container, the optical device obeying the relationship:
$$0.5 \leq 98 {V ( \frac{D}{Sd} )}^{0.5} \leq 5$$

2. An optical device as claimed in claim 1, the optical device obeying the relationship:
$$0.75 \leq 98 {V ( \frac{D}{Sd} )}^{0.5} \leq 2$$

3. An optical device as claimed in claim 1, wherein the relationship is obeyed in a temperature range of −30 to +60° Celsius.

4. An electronic device (1) comprising an optical device as claimed in claim 1.
